(19) United States
(12) Patent Application Publication
(10) Pub. No.: US 2016/0105807 A1
(43) Pub. Date: Apr. 14, 2016

(54) METHODS AND SYSTEMS FOR DETERMINING SIGNAL STRENGTH IN INDOOR ENVIRONMENTS

(71) Applicant: Xerox Corporation, Norwalk, CT (US)

(72) Inventors: Kuldeep Yadav, Haryana (IN); Abhishek Kumar, New Delhi (IN); Nischal Murthy Piratla, Fremont, CA (US)

(21) Appl. No.: 14/510,166

(22) Filed: Oct. 9, 2014

(51) Int. Cl. H04W 24/02; H04W 4/02

(52) U.S. Cl. CPC H04W 24/02; H04W 4/02

(57) ABSTRACT

Methods and systems for determining cellular signal strength information. The method includes receiving a location of interest, for which said cellular signal strength information is to be determined, from a customer-computing device. Thereafter, a crowdsourcing task corresponding to said location of interest is generated, wherein said crowdsourcing task comprises at least an instruction for a movement of a mobile device in said location of interest. The method further includes receiving at least one or more received signal strength indication (RSSI) values for said location of interest during said movement, wherein said received one or more RSSI values are utilizable to alert a user of a mobile device for a low RSSI value in said location of interest.

### TECHNICAL FIELD

The presently disclosed embodiments are related, in general, to determining signal strength. More particularly, the presently disclosed embodiments are related to methods and systems for determining cellular signal strength in indoor environments.

### BACKGROUND

The mobile phones have seen tremendous growth in recent years. To cater to such growth, mobile operators that provide network services to mobile users have to provide optimum network coverage at all the covered locations, in terms of signal quality at those locations. Low signal quality at a location may result into frequent call drops, degradation of the throughput, and high battery consumption for the mobile users. This may further lead to mobile customer's annoyance. Thus, the mobile operators deploy various means for determining/verifying the signal quality at various locations.

Typically, the mobile operators provide coverage maps that depict the coverage area served by the mobile operators. These coverage maps may be based on the cell stations deployed by the mobile operators in different locations, or may be based on site survey performed by mobile operators' RF engineers. However, typically, these coverage maps are performed for outdoor areas and does not include obstructed signal areas, such as building, tunnels, and underground garage/parking spaces. In addition, site surveys performed by the RF engineers may not be very frequent and may be performed only when there is an installation of new base station(s) or change in physical topography.

In addition, typically, call drops observed by the mobile users are due to low-signal zones in the indoor locations (e.g., in a building) where the signal strength quality is too low. After observing call drops in such low-signal zones, the users may call the customer care services provided by the mobile operators, and, subsequently, the mobile operators may decide to take actions (e.g., to install signal boosters and to perform the RF survey) based on the number of such complaints.

### SUMMARY

According to embodiments illustrated herein, there is provided a method for determining signal strength in an indoor environment. The method includes determining a received signal strength indication (RSSI) value at a first location of a mobile device. Said first location is determined by using at least one of a Global Positioning System (GPS), a barometer, or a user-input. The method further includes determining a movement of said mobile device from said first location by using at least an accelerometer and a compass. Said accelerometer determines a distance of said movement and said compass determines a direction of said movement. The method further includes notifying a user associated with said mobile device based at least on said movement and a historical data. Said historical data comprises information corresponding to detected signal strengths in said indoor environment. The method is performed by one or more processors.

According to embodiments illustrated herein, there is provided a method for determining cellular signal strength information. The method includes receiving a location of interest, for which said cellular signal strength information is to be determined, from a customer-computing device. The method further includes generating a crowdsourcing task corresponding to said location of interest. Said crowdsourcing task comprises at least an instruction for a movement of a mobile device in said location of interest. The method further includes receiving at least one or more received signal strength indication (RSSI) values for said location of interest during said movement. Said received one or more RSSI values are utilizable to alert a user of a mobile device for a low RSSI value in said location of interest. The method is performed by one or more processors.

According to embodiments illustrated herein, there is provided a system for determining signal strength in indoor environment. The system includes one or more processors operable to determine a received signal strength indication (RSSI) value at a first location of a mobile device. Said first location is determined by using at least one of a Global Positioning System (GPS), a barometer, or a user-input. The one or more processors are further operable to determine a movement of said mobile device from said first location by using at least an accelerometer and a compass. Said accelerometer determines a distance of said movement and said compass determines a direction of said movement. The one or more processors are further operable to notify a user associated with said mobile device based at least on said movement and a historical data. Said historical data comprises information corresponding to detected signal strengths in said indoor environment.

According to embodiments illustrated herein, there is provided a system for determining cellular signal strength information. The system includes one or more processors operable to receive a location of interest, for which said cellular signal strength information is to be determined, from a customer-computing device. The one or more processors are further operable to generate a crowdsourcing task corresponding to said location of interest. Said crowdsourcing task comprises at least an instruction for a movement of a mobile device in said location of interest. The one or more processors are further operable to receive at least one or more received signal strength indication (RSSI) values for said location of interest during said movement. Said received one or more RSSI values are utilizable to alert a user of a mobile device for a low RSSI value in said location of interest.

According to embodiments illustrated herein, there is provided a computer program product for use with a computer. The computer program product includes a non-transitory computer readable medium. The non-transitory computer readable medium stores a computer program code for determining signal strength in indoor environment. The computer program code is executable by one or more processors to determine a received signal strength indication (RSSI) value at a first location of a mobile device. Said first location is determined by using at least one of a Global Positioning System (GPS), a barometer, or a user-input. The computer program code is further executable by the one or more processors to determine a movement of said mobile device from said first location by using at least an accelerometer and a compass. Said accelerometer determines a distance of said movement and said compass determines a direction of said movement. The computer program code is further executable by the one or more processors to notify a user associated with said mobile device based at least on said movement and a historical data. Said historical data comprises information corresponding to detected signal strengths in said indoor environment.

According to embodiments illustrated herein, there is provided a computer program product for use with a computer. The computer program product includes a non-transitory computer readable medium. The non-transitory computer readable medium stores a computer program code for determining cellular signal strength information. The computer program code is executable by one or more processors to receive a location of interest, for which said cellular signal strength information is to be determined, from a customer-computing device. The computer program code is further executable by the one or more processors to generate a crowdsourcing task corresponding to said location of interest. Said crowdsourcing task comprises at least an instruction for a movement of a mobile device in said location of interest. The computer program code is further executable by the one or more processors to receive at least one or more received signal strength indication (RSSI) values for said location of interest during said movement. Said received one or more RSSI values are utilizable to alert a user of a mobile device for a low RSSI value in said location of interest.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a computing device, in accordance with at least one embodiment;

FIG. 3 is a first flowchart illustrating a method for determining signal strength in indoor environments, in accordance with at least one embodiment;

FIG. 4 is a second flowchart illustrating a method for determining signal strength in indoor environments, in accordance with at least one embodiment; and

FIGS. 5A, 5B, 5C, and 5D illustrate a block diagram illustrating a method for determining cellular signal strength, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “signal strength” refers to a measure of signal quality at a geographical location. In an embodiment, the signal strength may correspond to cellular signal strength, and may be measured through signal to noise ratio (SNR) value detected at the location. In an embodiment, the signal strength at the location may be represented through received signal strength indication (RSSI) value derived from the SNR value at the respective location.

An “indoor environment” refers to an area that may not have direct line of sight connectivity with the radio stations transmitting the radio waves. In an embodiment, the indoor environment may correspond to such obstructed signal areas. Examples of the indoor environment may include, but are not limited to, buildings, tunnels, garages, parking areas, basement areas, and the like.

A “historical data” refers to a repository of information pertaining to detected signal strengths at different geographical locations. For example, the historical data may include RSSI values and associated locations. In an embodiment, different locations in the historical data may be represented by latitude/longitude values of the respective locations.

A “profile information” refers to a repository of information pertaining to different mobile users. In an embodiment, the profile information may include various attributes associated with the mobile users, such as, but not limited to, age of the users, height of the users, gender of the users, and the like.

A “low-signal zone” refers to an area that has weak signal strength quality. In an embodiment, a predetermined threshold value of the signal strength may be configured to determine the low-signal zone. That is, if the area has signal strength quality less than the predetermined threshold, the area would be considered low-signal zone.

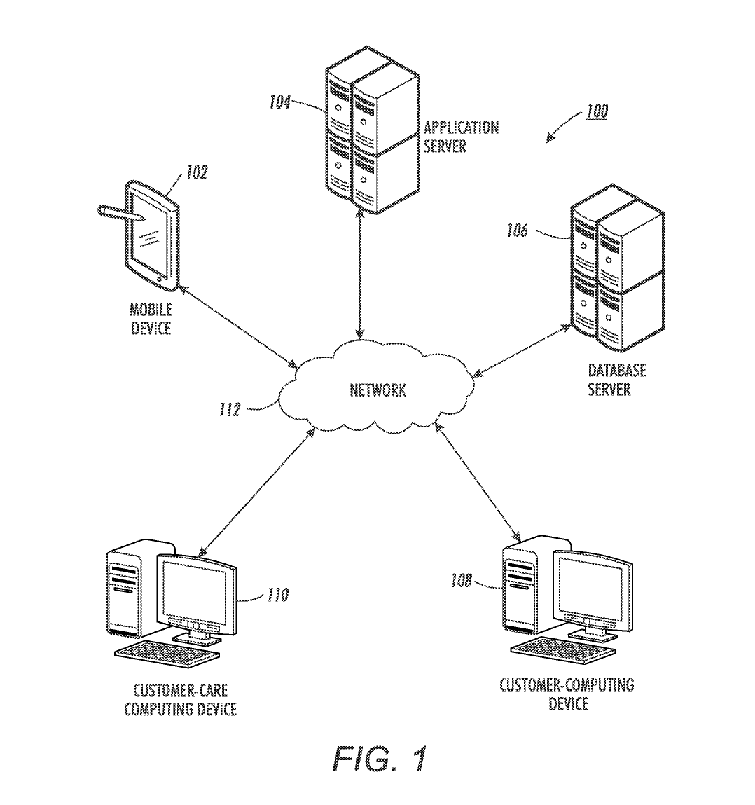

FIG. 1 is a block diagram illustrating a system environment 100 in which various embodiments may be implemented. The system environment 100 includes a mobile device 102, an application server 104, a database server 106, a customer-computing device 108, a customer-care computing device 110, and a network 112. Various devices in the system environment 100 (e.g., the mobile device 102, the application server 104, the database server 106, the customer-computing device 108, and the customer-care computing device 110) may be interconnected over the network 112.

The mobile device 102 refers to a computing device used by a user. In an embodiment, the mobile device 102 may be used for one or more purposes, such as, but not limited to, voice calling, text messages, internet connectivity, and the like. In an embodiment, an application/tool/framework for determining cellular signal strength in indoor environments may be installed on the mobile device 102. Further, the mobile device 102 may include one or more sensors, such as, but not limited to, a Global Positioning System (GPS) sensor, an accelerometer, a barometer, a compass, and a Wi-Fi sensor. The mobile device 102 may determine its location information and movement based on these sensors. Further, the mobile device 102 may include a radio transceiver that may sense radio signals transmitted by one or more radio stations (e.g., cellular radio stations). The mobile device 102 may determine a RSSI value based on the SNR value detected by the radio transceiver at the location of the mobile device 102. In an embodiment, the mobile device 102 may have a display device associated with it that may be utilized for displaying the location information of the mobile device 102 (e.g., through a map interface) and associated RSSI values at those locations. The mobile device 102 may include one or more input devices (e.g., a touch interface and a keyboard) that may be utilized by the user to provide one or more inputs. For example, the user may provide information pertaining to his/her location (e.g., information of building/floor number, in which the mobile device 102 is located). The mobile device 102 may include various types of the computing devices, such as, but not limited to, a laptop, a personal digital assistant (PDA), a smart-phone, a tablet computer (e.g., iPad®, Samsung Galaxy Tab®), and the like.

The application server 104 refers to a computing device that may receive information pertaining to RSSI values and associated locations of the one or more mobile devices. In an embodiment, the application server 104 may receive a location of interest from the customer-computing device 108. The location of interest may correspond to a location at which a customer (e.g., a network service provider) wants to know about signal strength quality. In an embodiment, the application server 104 may generate a crowdsourcing task to collect RSSI information at different points in the location of interest. Further, the application server 104 may transmit such determined RSSI values to the customer-computing device 108. In an embodiment, the application server 104 may transmit the determined RSSI values along with the associated locations to the customer-care computing device 110. In an embodiment, the application server 104 may store determined RSSI values and associated location information in the database server 106 for later retrieval. The application server 104 may be realized through an application server such as, but not limited to, Java application server, .NET framework, Base4 application server, and Appaserver.

The database server 106 refers to a computing device that may store information pertaining to signal strength (i.e., RSSI values) from one or mobile devices. Thus, the database server 106 may store the historical data that includes the information about the RSSI values at different locations of the mobile device 102. The database server 106 may receive such information from the application server 104. In an embodiment, the database server 106 may receive a query from the application server 104 to retrieve the information stored in the database server 106. For querying the database server 106, one or more querying languages may be utilized such as, but not limited to, SQL, QUEL, DMX and so forth. Further, the database server 106 may be realized through various technologies such as, but not limited to, Microsoft® SQL server, Oracle, and My SQL. In an embodiment, the database server 106 may connect to the application server 104, using one or more protocols such as, but not limited to, ODBC protocol and JDBC protocol.

It will be apparent to a person skilled in the art that the functionalities of the database server 106 may be incorporated into the application server 104, without departing from the scope of the disclosure.

The customer-computing device 108 refers to a computing device used by the customer (e.g., a network service provider). In an embodiment, the customer-computing device 108 may be utilized by the customer to provide one or more inputs to the application server 104. In an embodiment, the customer may provide a location of interest, where he/she wants to know about the signal strength quality. For example, the customer may provide information about an area/building as a location of interest. The customer may provide such information through a user-interface presented by the application server 104 on a display device associated with the customer-computing device 108. Further, the customer may view the determined RSSI values at the location of interest through the user-interface. Based on the displayed information about the RSSI values at the location of interest, the customer may take different decisions, such as installing signal boosters at the location of interest, performing RF survey at the location of interest, and the like. The customer-computing device 108 may include various types of computing devices, such as, but not limited to, a desktop computer, a laptop, a personal digital assistant (PDA), a smart-phone, a tablet computer (e.g., iPad®, Samsung Galaxy Tab®), and the like.

The customer-care computing device 110 refers to a computing device used by a customer-care representative. In an embodiment, the customer-care computing device 110 may receive RSSI values from the application server 104 corresponding to different locations associated with the mobile device 102. The customer-care computing device 110 may include a display device on which these RSSI values, along with associated locations, may be displayed. Further, the customer-care representative may guide the user of the mobile device 102 to move in different directions based on the displayed RSSI values. In an embodiment, the motivations for such guidance may be to collect signal strength quality at the locations of the mobile device 102. The customer-care computing device 110 may include various types of computing devices, such as, but not limited to, a desktop computer, a laptop, a personal digital assistant (PDA), a smart-phone, a tablet computer (e.g., iPad®, Samsung Galaxy Tab®), and the like.

The network 112 corresponds to a medium through which content and messages flow between various devices of the system environment 100 (e.g. the mobile device 102, the application server 104, the database server 106, the customer-computing device 108, and the customer-care computing device 110). Examples of the network 112 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

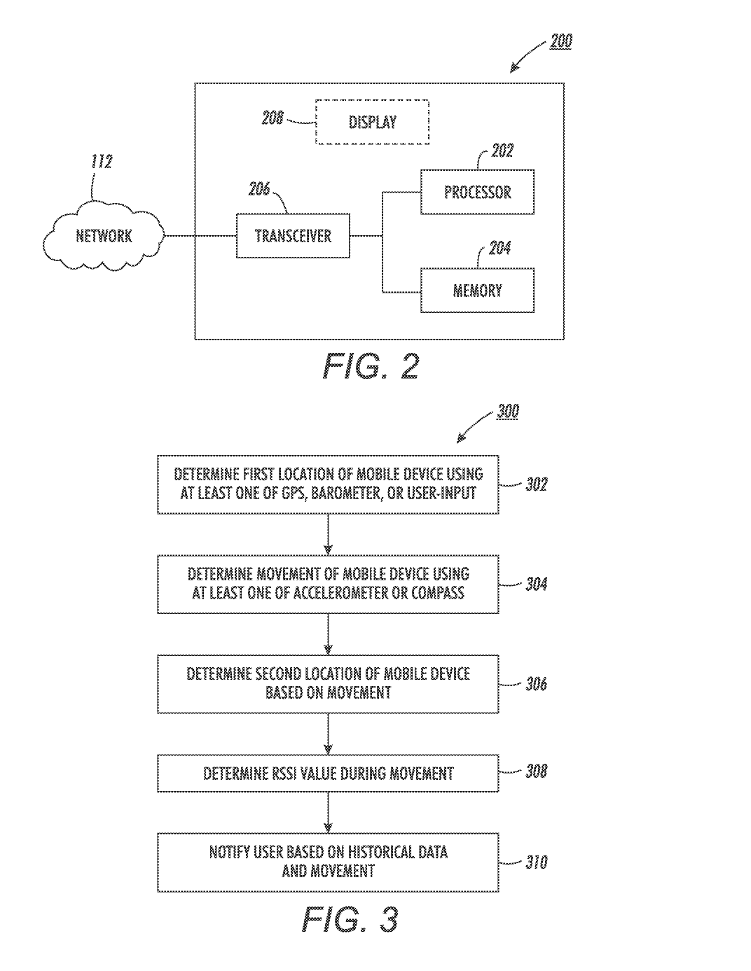

FIG. 2 is a block diagram illustrating a computing device 200, in accordance with at least one embodiment. The computing device 200 includes a processor 202, a memory 204, a transceiver 206, and a display 208. The computing device 200 may correspond to at least one of the mobile device 102 or the application server 104.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an ×86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It will be apparent to a person having ordinary skills in the art that the one or more instructions stored in the memory 204 enables the hardware of the computing device 200 to perform the predetermined operation.

The transceiver 206 transmits and receives messages and data to/from various components of the system environment 100. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

The display 208 facilitates the user/customer to view information and interact with the computing device 200. The display 208 may be realized through several known technologies, such as Cathode Ray Tube (CRT) based display, Liquid Crystal Display (LCD), Light Emitting Diode (LED)-based display, Organic LED display technology, and Retina Display technology. In an embodiment, the display 208 can be a touch screen that is operable to receive a user-input.

The operation of the computing device 200 for determining signal strength in indoor environments has been described in conjunction with FIG. 3.

FIG. 3 is a flowchart 300 illustrating a method for determining signal strength in indoor environments, in accordance with at least one embodiment. The flowchart 300 is described in conjunction with FIG. 1 and FIG. 2. For the purpose of description of the flowchart 300, the computing device 200 corresponds to the mobile device 102.

At step 302, a first location of the mobile device 102 is determined. In an embodiment, the processor 202 associated with the mobile device 102 determines the first location using one or more sensors (e.g., GPS and barometer) included in the mobile device 102. For example, the GPS sensor included in the mobile device 102 may estimate the location of the mobile device 102 (e.g., the building in which the mobile device 102 is located). In an embodiment, this estimated location may be displayed to the user on the display 208 associated with the mobile device 102. Using the displayed location information, the user may change/verify the estimated location. In an alternate embodiment, the user may himself/herself provide the location of the mobile device 102 using the input devices associated with the mobile device 102.

In an embodiment, to determine further information about the first location of the mobile device 102, the processor 202 may estimate the floor number on which the mobile device 102 is located. The processor 202 may estimate the floor number using the barometer sensor included in the mobile device 102. In an embodiment, the barometer sensor determines the atmospheric pressure at the location of the mobile device 102. Subsequently, the processor 202 may estimate the floor number based on this atmospheric pressure. In an embodiment, the estimated floor number is displayed to the user, who may change/verify the estimated floor number. For example, it may be displayed to the user that the estimated floor number is fourth floor. Subsequently, the user may change/verify the floor number based on the actual floor number on which the mobile device 102 is located.

In an embodiment, the processor 202 may determine the details pertaining to the network service provider associated with the mobile device 102. For example, using the signals detected by the radio transceiver in the mobile device 102, the processor 202 may determine the information, such as, International Mobile Subscriber Identity (IMSI) series associated with the network service provider.

At step 304, the movement of the mobile device 102 is determined. In an embodiment, the processor 202 determines the movement of the mobile device 102 using sensors (e.g., accelerometer and compass) included in the mobile device 102. For example, the accelerometer may determine the change in the coordinates associated with the first location of the mobile device 102. In an embodiment, the processor 202 may determine a threshold value for change in coordinates that may be neglected by the processor 202 as noise. (e.g., when the change in coordinates is detected even when the mobile device 102 is not moving). Further, the compass may determine the direction of the movement of the mobile device 102. For example, the processor 202 may determine, using the compass sensor, an angle θ between the magnetic north direction and the y-axis, around the z-axis.

In an embodiment, based on the determined movement of the mobile device 102, the processor 202 may determine the number of steps taken the by the user in the direction of the movement. For example, if the change in the coordinates of the location of the mobile device 102 is x, y, and z, along the x-axis, y-axis, and z-axis, the processor 202 may determine the distance of the movement as:

d=\sqrt{x²+y²+z²} (1)

where,

d=distance of the movement.

Subsequently, the processor 202 may determine the number of steps based on the value of d. In an embodiment, the processor 202 may utilize the profile information associated with the user to determine the number of steps. That is, the processor 202 may estimate the length of step-size based on the profile associated with the user. For example, the processor 202 may consider the age of the user, the height of the user, the gender of the user to determine the step-size. Thus, based on the estimated step-size and the value of d, the processor 202 may determine the number of steps taken along the direction of the movement.

At step 306, a second location of the mobile device 102 is determined based on the detected movement. In an embodiment, if the first location corresponds to the coordinates φ₁,λ₁, the processor 202 may determine the coordinates corresponding to the second location (φ₂,λ₂) using following equation:

$$\begin{matrix}{ϕ}_{2} = asin ( sin ( {ϕ}_{1} ) * cos ( \frac{d}{R} ) + cos ( {ϕ}_{1} ) * sin ( d / R ) * cos ( θ ) ) & ( 2 ) \\ {λ}_{2} = {λ}_{1} + atan 2 ( sin ( θ ) * sin ( \frac{d}{R} ) * cos ( {ϕ}_{1} ) , cos ( d / R ) - sin ( {ϕ}_{1} ) * sin ( {ϕ}_{2} ) ) & ( 3 )\end{matrix}$$

where,

φ=latitude of the respective location (i.e., first/second) of the mobile device 102,

λ=longitude of the respective location of the mobile device 102,

θ=bearing angle (in radians) clockwise from north,

d=distance travelled in accordance with equation (1), and

R=radius of Earth.

At step 308, RSSI values are determined during the movement of the mobile device 102. For example, the processor 202 may determine first RSSI value corresponding to first location of the mobile device 102 and second RSSI value corresponding to the second location of the mobile device 102. In an embodiment, the processor 202 may determine the RSSI values based on the SNR value detected by the radio transceiver in the mobile device 102. For example, if the radio transceiver detects the SNR value of 25, the processor 202 may determine the corresponding RSSI value as −63 dBm.

In an embodiment, the processor 202 may determine RSSI values at preconfigured time intervals. For example, the processor 202 may determine RSSI values at every 30 seconds; however, it will be apparent to a person skilled in the art that any time interval may be selected based on the specific requirements.

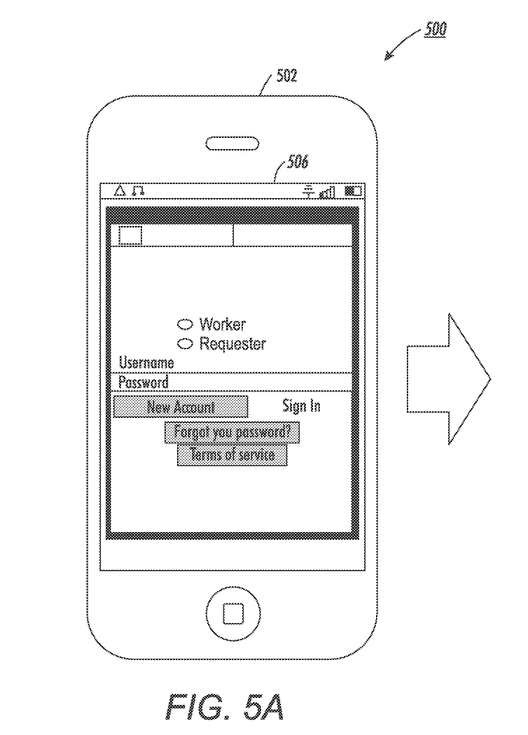

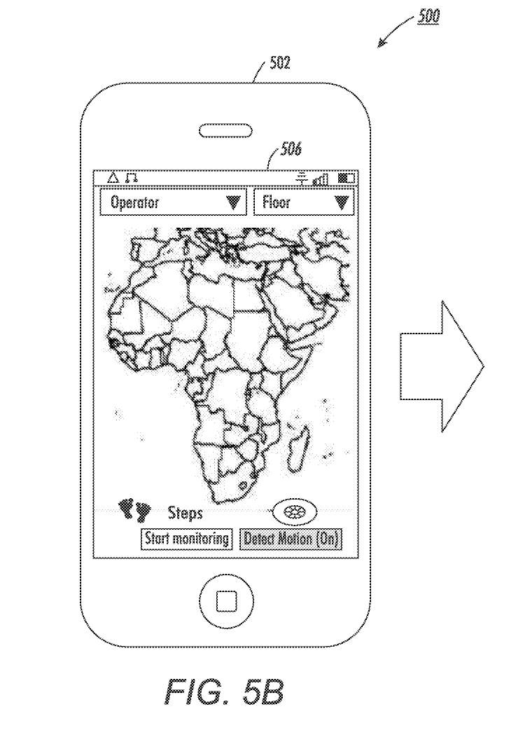

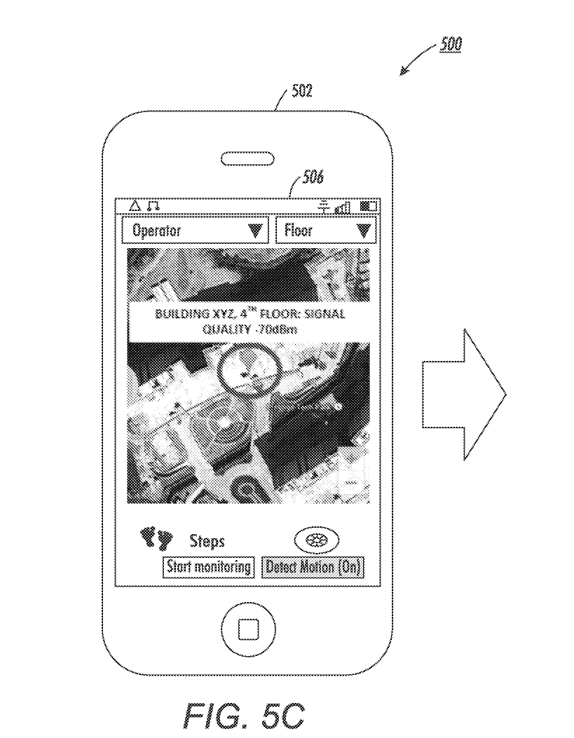

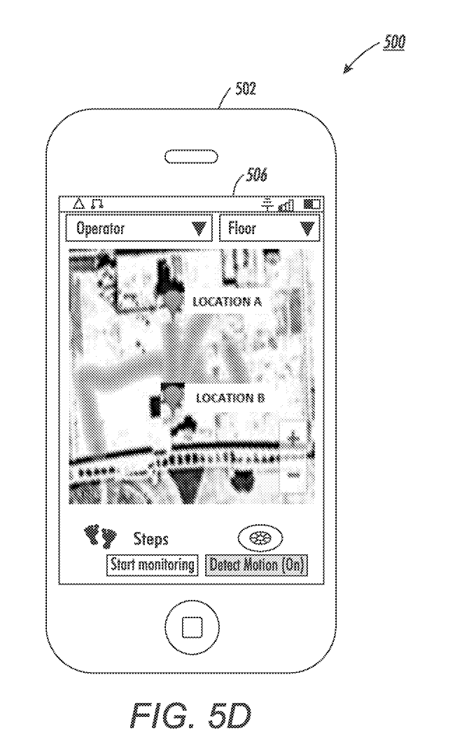

In an embodiment, the determined RSSI values may be displayed on the display 208. Further, the RSSI values may be displayed along with the associated location information. For example, the processor 202 may display a walking trail of the RSSI values overlaid on a map interface, as the user moves from the first location to the second location. In this way, the user may view the movement of the mobile device 102 along with varying RSSI values at the respective locations. Further illustration of such scenario has been discussed in conjunction with FIG. 5.

At step 310, the user may be notified. The processor 202 may notify the user based at least on the movement of the user and the historical data. In an embodiment, the mobile device 102 may pro-actively download the historical data from the application server 104. For example, as the internet connection on the mobile device 102 is found to be available (e.g., through Wi-Fi), the processor 202 may download the historical data from the application server 104. In an embodiment, such historical data downloaded from the application server 104 may correspond to the detected RSSI values at the location of the mobile device 102. For example, if the mobile device 102 is located in building “X”, the processor 202 may download previously determined RSSI values at different points in the building “X”. Thus, based on the movement of the user and such historical data, the processor 202 may determine if the user is heading towards a low-signal zone. In an embodiment, if the processor 202 determines that the mobile device 102 is heading towards the low-signal zone, the processor 202 may notify the user. The notification to the user may be through various means, such as, but not limited to, a ringtone alert, a vibration alert, a voice alert, and the like. In an embodiment, the processor 202 may determine a preconfigured threshold value of RSSI value to alert the user. For example, if the processor 202 determines the preconfigured threshold value of −90 dBm, and if the user is heading towards the area where the RSSI value (as per historical data) is −90 dBm, the processor 202 may notify the user. Further, the processor 202 may determine a threshold value of the distance, at which the user would be notified for the low-signal zone. For example, it may be configured that at a distance of 5 meters from the start of the low-signal zone, the user will be notified, if he/she is heading towards the low-signal zone. In an embodiment, the user is notified during the telephonic conversation. In this way, if the user is alerted during the conversation, the user may avoid call drop at that location due to low-signal strength.

In an embodiment, the intensity of the alert may be varied as the user approaches the low-signal zone. For example, it may be configured that at the distance of 10 meters from the start of the low-signal zone, intensity of the alert (e.g., a ringtone alert) will be a volume level of “5” and at the distance of 5 meters from the start of the low-signal zone, intensity of the alert will be raised to a volume level of “10”.

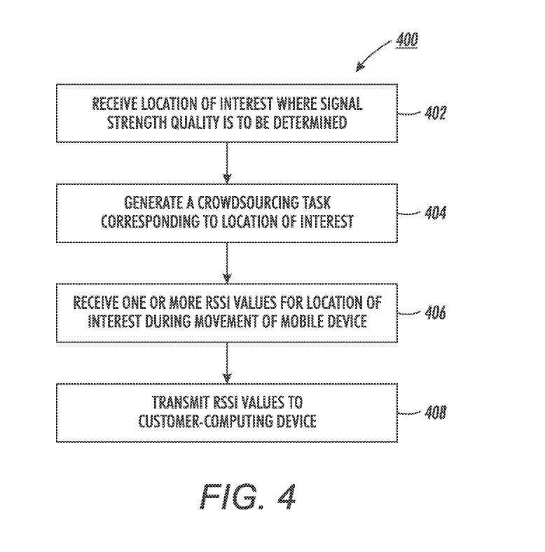

FIG. 4 is a flowchart 400 illustrating another method for determining signal strength in indoor environments, in accordance with at least one embodiment. The flowchart 400 is described in conjunction with FIG. 1, FIG. 2, and FIG. 3. For the purpose of the description of the flowchart 400, the computing device 200 corresponds to the application server 104.

At step 402, a location of interest is received by the processor 202. In an embodiment, the customer may want to know about the signal strength quality at the location of interest. In such a scenario, the customer may access the application server 104 (e.g., through a web interface) using the customer-computing device 108. Subsequently, the customer may provide the location of interest through a user-interface presented on the customer-computing device 108. For example, the customer may select an area on a map interface presented on the user-interface as the location of interest. The customer may select the location of interest through input devices associated with the customer-computing device 108 (e.g., a touch interface and a keyboard). In an embodiment, the customer may provide further details about the location of the interest. For example, the customer may zoom the map interface presented through the user-interface, and may subsequently select a building in which signal strength quality is to be determined.

At step 404, a crowdsourcing task corresponding to the location of interest is generated. The processor 202 generates the crowdsourcing task to collect the signal strength quality at the location of the interest selected by the customer. The processor 202 may transmit the crowdsourcing task to one or more mobile devices located in the location of interest. In an embodiment, the crowdsourcing task may be transmitted using the cellular network that may include information pertaining to different areas served by the cellular network. Using such information, the area that serves the location of interest may be determined and the crowdsourcing task may be transmitted to the one or more mobile devices located in the location of interest.

In an embodiment, the crowdsourcing task may include an executable file. The executable file may install an application on the mobile device 102, as soon as the user attempts the crowdsourcing task. In an embodiment, the application installed on the mobile device 102 displays a video on the mobile device 102, such that the video demonstrates a movement of the user so that signal quality (i.e., RSSI values) at the respective locations may be collected. In an embodiment, the user may perform the crowdsourcing task after providing further information about the location of interest. For example, the user may provide the name of the building in the location of interest, or may provide the floor number in the building. Post providing such information, the user may move in the location of interest (e.g., by referring to the illustration in the video) to facilitate the transmission of the RSSI values at different points in the location of interest.

In an embodiment, the crowdsourcing task may also include the information pertaining to the remuneration for the users for performing the task (i.e., facilitating the transmission of RSSI values by moving in the location of interest). The processor 202 may receive such information pertaining to the remuneration from the customer-computing device 108. In an embodiment, the remuneration may be based on the count of the low-signal zones identified by the user. In an alternate embodiment, the remuneration may be based on the area covered by the user during the movement.

At step 406, one or more RSSI values are received by the processor 202. The processor 202 may receive one or more RSSI values from the mobile device 102 during the movement of the user. As discussed in conjunction with the flowchart 300, the mobile device 102 may transmit the RSSI values, during the movement, after a time that may be preconfigured in the mobile device 102.

At step 408, the received RSSI values are transmitted to the customer-computing device 108. In an embodiment, the processor 202 may transmit the received RSSI values to the user-interface presented on the customer-computing device 108. Further, the customer may view the RSSI values on the user-interface to determine signal strength quality in the location of interest. In an embodiment, the customer may download such presentation in a format that is compatible with the customer-computing device 102 (e.g., PDF, PNG, JPEG, and the like). In an embodiment, the processor 202 may transmit the remuneration to the users for performing the crowdsourcing task.

In an embodiment, the received RSSI values from different mobile devices may be stored in the database server 106, and retrieved, as and when required, for transmitting to a mobile device as the historical data, as discussed in conjunction with the flowchart 300.

In an embodiment, the application installed on the mobile device 102 may be utilized by the customer-care representative to facilitate the resolution of the user's complaint. For example, the user of the mobile device 102 may call the customer-care representative for a low signal quality problem in his/her location. Subsequently, the customer-care representative may ask the user to open the application installed in the mobile device 102. The application may determine the RSSI values (as discussed in conjunction with the flowchart 300) and may transmit such determined RSSI values to the user-interface on the customer-care computing device 110. In an embodiment, the RSSI values may be displayed on the user-interface on the customer-care computing device 110 along with the associated location information. Subsequently, based on such display, the customer-care representative may guide the user to move in different directions such that RSSI values during that movement may be determined. Based on the RSSI values during the movement, the customer-care representative may determine the signal strength quality problems at the location of the mobile device 102.

It will be apparent to a person skilled in the art that though the flowcharts 300 and 400 have been described for indoor environments, the methods disclosed through these flowcharts may be used for outdoor environments, without departing from the scope of the disclosure.

FIGS. 5A, 5B, 5C, and 5D illustrate a block diagram 500 that illustrates method for determining cellular signal strength, in accordance with at least one embodiment. The block diagram 500 includes a mobile device 502. The mobile device 502 further includes a display area 506. Further, FIGS. 5A, 5B, 5C, and 5D correspond to four interfaces viewed by the user of the mobile device 502. For the purpose of the description of the block diagram 500, the mobile device 502 corresponds to the mobile device 102 used by the user as discussed in conjunction with FIG. 1-FIG. 4. However, in an alternate embodiment, the mobile device 502 may also correspond to the customer-computing device 108, without departing from the scope of the disclosure. FIGS. 5A, 5B, 5C, and 5D have been described in conjunction with the FIG. 3 and FIG. 4.

The FIG. 5A depicts a user interface that may be utilized by the user to access the application. In an embodiment, the user may provide the credentials (e.g., username and password) to access the application, as depicted in the FIG. 5A. As discussed in conjunction with the flowchart 400, the application may be installed on the mobile device 502 when the user attempts the crowdsourcing task transmitted to him/her by the application server 104. In an embodiment, the user may himself/herself install the application on the mobile device 502 by downloading the application from internet. In an embodiment, by selecting the option “worker”, the user signals the application that the mobile device 502 corresponds to a worker who wants to perform the crowdsourcing tasks. Further, the user may open the application during the telephonic conversation with the customer-care representative so that RSSI values may transmitted to the customer-care computing device 110, as discussed in conjunction with the flowchart 400.

It will be apparent to a person skilled in the art that in case, when the mobile device 502 corresponds to the customer-computing device 108, the customer associated with the mobile device 502 may select the option “requester” that is depicted in the FIG. 5A.

The FIG. 5B depicts a map interface that may be displayed to the user, once the user selects the option “worker”. In an embodiment, the location of the user may be determined as discussed in conjunction with the flowchart 300 (e.g., through GPS). Further, the user may be displayed options to select operator (i.e., network service provider) or to provide further information (e.g., floor number) about the location of the user. In addition, the FIG. 5B depicts that the numbers of steps taken by the user and the direction of the user may also be displayed to the user. Since, the user is not moving in the FIG. 5B, number of steps has no value against it. In an embodiment, the user may zoom the displayed map interface to view his/her current location (i.e., first location as discussed in conjunction with the flowchart 300).

The FIG. 5C depicts the zoomed map interface displayed on the mobile device 502. Further, the zoomed map interface displays the current location (i.e., the first location) of the mobile device 502. As discussed in conjunction with the flowchart 300, the user is displayed the detailed information including the name of the building and the floor number estimated by the processor 202. Further details about the determination of the detailed location information have already been discussed in conjunction with the flowchart 300. In an embodiment, the user may change/verify the estimated location information. For example, as depicted, the processor 202 estimates the current location of the mobile device 502 as building XYZ and the floor number “4^{th} floor”. If the user observes that estimated location information is not correct, the user may change the location. For example, the user may provide the floor number through the drop down option of “floor” as depicted in the FIG. 5C. In a similar way, if the user observes that the estimated building (i.e., building “XYZ”) is not correct, the user may change the building information by further zooming the map interface and selecting the building (e.g., through marking on the map interface) in which the user is located. As depicted in the FIG. 5C, the user may also be displayed signal strength information along with the location information. For example, as depicted the user observes that the signal strength at the current location of the user is −70 dBm.

The FIG. 5D depicts another interface that the user may view on the display area 506 of the mobile device 502. The FIG. 5D depicts that the user has taken 10 steps from the first location (depicted location A) to the second location (depicted as location B). As discussed in conjunction with the flowchart 300, the processor 202 may detect the movement of the user based on the accelerometer sensor in the mobile device 502. Further, the processor 202 may detect the direction of the movement of the user using compass sensor. As depicted, the user may view the walking trail of the signal strength from the location A to the location B. In an embodiment, the signal strength may be represented through different colors. For example, areas with the weaker signal strength may be colored with red dots and areas with stronger signal strength may be colored with green dots. In an embodiment, the user has the option to display the signal quality at the different points in the building. For example, as depicted in the FIG. 5D, the user may view green dots representing availability of strong signals at different points in the building XYZ. Though, in the FIG. 5D, only some of the points have been displayed (as illustration) for the building XYZ. In an embodiment, the complete interface displayed to the user may be overlaid with red/green dots representing signal strength quality in the building XYZ.

In an embodiment, the user may be notified based on the movement of the user and the historical data, as discussed in conjunction with the flowchart 300.

In an embodiment, the information about the movement and the determined RSSI values may be transmitted to the customer-care representative, as discussed in conjunction with the flowchart 400. Further, the customer-care representative may guide the user to move in different directions to collect the signal quality information at the location of the user.

The disclosed embodiments encompass numerous advantages. Typically, the network service providers advertise the coverage maps (for signal quality) for the areas covered by their network services based on the installed cell stations. In addition, although the coverage maps be generated by these network service providers by performing RF site surveys, these coverage maps provide coverage information for outdoor environments only. Through various embodiments of methods and systems for determining signal strength, it is disclosed that the network service providers may view the signal quality for indoor environments also, in the areas covered through their services. Since, the information about the signal quality is collected through different mobile devices located in those indoor areas, detailed information about signal quality may be viewed, and subsequently analyzed, by the network providers. Thus, based on such analysis, the network service providers may take crucial decisions, such as where to install signal booster, whether to perform RF survey, and the like. In this way, network service providers may be better able to cater to the problems caused by signal quality, such as call drops, call disturbance, etc.

In addition, it is disclosed that the users of mobile device may be pro-actively alerted if they are approaching a low-signal strength zone. That is, the users may be alerted before the call termination, and thus the users may not face the call drop, which they could have without such alert.

In addition, the disclosed embodiment may provide a better way to solve customer complaints related to signal quality. For example, as discussed, when the user calls the customer-care representative for a signal quality related problem, he may be guided by the customer-care representative to move in different directions, and facilitate in providing signal quality at different points in his/her location. Since the customer-care representative views the location/movement and associated RSSI values, in real time, on the user-interface, the issue related to signal quality may be better identified. Thus, based on the feedback provided by the customer-care representative, the network service provider may take the necessary actions to solve the complaint.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for determining signal strength in indoor environments have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for determining cellular signal strength information, the method comprising:
receiving, by one or more processors, a location of interest, for which said cellular signal strength information is to be determined, from a customer-computing device;
generating, by said one or more processors, a crowdsourcing task corresponding to said location of interest, wherein said crowdsourcing task comprises at least an instruction for a movement of a mobile device at one or more locations in said location of interest;
transmitting, by said one or more processors, said crowdsourcing task to one or more mobile devices located in said location of interest; and
receiving, by said one or more processors, at least one or more received signal strength indication (RSSI) values for said one or more locations in said location of interest during said movement of said one or more mobile devices in said location of interest, wherein said received one or more RSSI values are utilizable to notify a user of a mobile device in said location of interest for a low RSSI value in said location of interest.

2. The method of claim 1 further comprising receiving, by said one or more processors, an information pertaining to rewards associated with said crowdsourcing task from said customer-computing device, wherein said rewards are based on at least one of a count of location points identified where said RSSI value is lower than a pre-determined threshold, or an area covered by said mobile device during said movement.

3. The method of claim 1, wherein said crowdsourcing task comprises an executable file corresponding to an application to be installed on said mobile device.

4. The method of claim 3, wherein said application displays a video on said mobile device, wherein said video comprises a demonstration of said movement to perform said crowdsourcing task.

5. The method of claim 1, wherein said crowdsourcing task comprises a request to provide further details of said location of interest, wherein said further details comprise an information about a building in which said mobile device is located and an information about a floor number, in said building, on which said mobile device is located.

6. The method of claim 1 further comprising transmitting, by said one or more processors, said one or more RSSI values, along with information pertaining to associated locations, to at least one of a display device associated with said customer-computing device or a display device associated with a customer-care computing device.

7. The method of claim 6, wherein a customer-care representative associated with said customer-care computing device guides said user of said mobile device for said movement based on displayed one or more RSSI values, along with said information pertaining to associated locations, on said customer-care computing device.

8. The method of claim 7, wherein said user is in telephonic conversation with said customer-care representative.

9. A system for determining cellular signal strength information, the system comprising:
one or more processors operable to:
receive a location of interest, for which said cellular signal strength information is to be determined, from a customer-computing device;
generate a crowdsourcing task corresponding to said location of interest, wherein said crowdsourcing task comprises at least an instruction for a movement of a mobile device at one or more locations in said location of interest;
transmit said crowdsourcing task to one or more mobile devices located in said location of interest; and
receive at least one or more received signal strength indication (RSSI) values for said one or more locations in said location of interest during said movement of said one or more mobile devices in said location of interest, wherein said received one or more RSSI values are utilizable to notify a user of a mobile device in said location of interest for a low RSSI value in said location of interest.

10. The system of claim 9, wherein said one or more processors are further operable to receive an information pertaining to rewards associated with said crowdsourcing task from said customer-computing device, wherein said rewards are based on at least one of a count of location points identified where said RSSI value is lower than a pre-determined threshold, or an area covered by said mobile device during said movement.

11. The system of claim 9, wherein said crowdsourcing task comprises an executable file corresponding to an application to be installed on said mobile device.

12. The system of claim 11, wherein said application displays a video on said mobile device, wherein said video comprises a demonstration of said movement to perform said crowdsourcing task.

13. The system of claim 9, wherein said crowdsourcing task comprises a request to provide further details of said location of interest, wherein said further details comprise an information about a building in which said mobile device is located and an information about a floor number, in said building, on which said mobile device is located.

14. The system of claim 9, wherein said one or more processors are further operable to transmit said one or more RSSI values, along with information pertaining to associated locations, to at least one of a display device associated with said customer-computing device or a display device associated with a customer-care computing device.

15. The system of claim 14, wherein a customer-care representative associated with said customer-care computing device guides said user of said mobile device for said movement based on displayed one or more RSSI values, along with said information pertaining to associated locations, on said customer-care computing device.

16. The system of claim 15, wherein said user is in telephonic conversation with said customer-care representative.

17. A computer program product for use with a computer, the computer program product comprising a non-transitory computer readable medium, wherein the non-transitory computer readable medium stores a computer program code for determining cellular signal strength information, wherein the computer program code is executable by one or more processors to:
receive a location of interest, for which said cellular signal strength information is to be determined, from a customer-computing device;
generate a crowdsourcing task corresponding to said location of interest, wherein said crowdsourcing task comprises at least an instruction for a movement of a mobile device at one or more locations in said location of interest;
transmit said crowdsourcing task to one or more mobile devices located in said location of interest; and
receive at least one or more received signal strength indication (RSSI) values for said one or more locations in said location of interest during said movement of said one or more mobile devices in said location of interest, wherein said received one or more RSSI values are utilizable to notify a user of a mobile device in said location of interest for a low RSSI value in said location of interest.
